(19) United States
(12) Patent Application Publication
(10) Pub. No.: US 2023/0186320 A1
(43) Pub. Date: Jun. 15, 2023

(54) COASTAL FENESTRATION PRODUCT SYSTEM

(71) Applicant: Andersen Corporation, Bayport, MN (US)

(72) Inventors: Josef Hubert Wegele, Cottage Grove, MN (US); Eric Lee Ottem, River Falls, WI (US); Katherine April Stephan Graham, Inver Grove Heights, MN (US); Mert Okyay, Minneapolis, MN (US)

(21) Appl. No.: 17/941,687

(22) Filed: Sep. 9, 2022

Related U.S. Application Data
(60) Provisional application No. 63/242,871, filed on Sep. 10, 2021.

(51) Int. Cl. G06Q 30/018; G06T 11/00

(52) U.S. Cl. CPC G06Q 30/018; G06T 11/00; G06T 2200/24; G06T 2210/04

(57) ABSTRACT

Embodiments herein relate to coastal fenestration product systems and related methods. In an embodiment, a coastal fenestration product system can be included having a control circuit and a geolocation circuit. The geolocation circuit can be in electronic communication with the control circuit and can be configured to determine a geolocation of a building. The coastal fenestration product system can be configured to receive an input from a system user regarding the building and fenestration locations therein and determine a required level of performance for one or more fenestrations of the building based on the input from the system user and the geolocation of the building. Other embodiments are also included herein.

This application claims the benefit of U.S. Provisional Application No. 63/242,871, filed Sep. 10, 2021, the content of which is herein incorporated by reference in its entirety.

### FIELD

Embodiments herein relate to coastal fenestration product systems and related methods.

### BACKGROUND

Tropical storms and hurricanes can include high wind speeds resulting in substantial wind loads on fenestrations of buildings. The high wind speeds can also result in objects being picked up by the wind and becoming dangerous wind driven projectiles. Such projectiles can cause glass breakage and other damage to buildings and components thereof such as windows and doors.

To prevent damage and possible injuries from high wind speeds and wind carried projectiles, building codes and standards for certain coastal areas have been established and require that fenestrations meet certain requirements for high wind loads and impact resistance. The specific requirements that fenestrations must meet are dependent on, amongst other things, the wind zone of the geolocation of the building into which the fenestrations will be installed.

Fenestrations can vary widely in their performance with respect to high wind loads and flying projectiles. This can make it challenging to select appropriate fenestrations for a given building while making both the requirements for and the performance of specific fenestrations clear for stakeholders including product consultants, building owners, and regulatory authorities.

### SUMMARY

Embodiments herein relate to coastal fenestration product systems and related methods. In a first aspect, a coastal fenestration product system can be included having a control circuit and a geolocation circuit. The geolocation circuit can be in electronic communication with the control circuit and can be configured to determine a geolocation of a building. The coastal fenestration product system can be configured to receive an input from a system user regarding the building and fenestration locations therein and determine a required level of performance for one or more fenestrations of the building based on the input from the system user and the geolocation of the building.

In a second aspect, in addition to one or more of the preceding or following aspects, or in the alternative to some aspects, the coastal fenestration product system can be configured to determine a wind speed zone based on the geolocation of the building to determine a required performance level for one or more fenestrations of the building.

In a third aspect, in addition to one or more of the preceding or following aspects, or in the alternative to some aspects, the coastal fenestration product system can be configured to calculate a proximity to an adjacent wind speed zone.

In a fourth aspect, in addition to one or more of the preceding or following aspects, or in the alternative to some aspects, the coastal fenestration product system can be configured to identify a wind loading rating of one or more fenestrations for installation in the building.

In a fifth aspect, in addition to one or more of the preceding or following aspects, or in the alternative to some aspects, the coastal fenestration product system can be configured to identify a selected fenestration as having a sufficient or insufficient wind loading rating with respect to the determined wind loading requirement level.

In a sixth aspect, in addition to one or more of the preceding or following aspects, or in the alternative to some aspects, further can include an image generation circuit, wherein the image generation circuit can be in electronic communication with the control circuit and can be configured to generate an output for a visual user interface displaying the wind loading requirement level for one or more fenestrations of the building and a wind loading rating of a replacement fenestration.

In a seventh aspect, in addition to one or more of the preceding or following aspects, or in the alternative to some aspects, the output for the visual user interface can be configured based on a role identity of the system user.

In an eighth aspect, in addition to one or more of the preceding or following aspects, or in the alternative to some aspects, the image generation circuit can be configured to generate an image of a fenestration location of the building with an image of a replacement fenestration superimposed thereon.

In a ninth aspect, in addition to one or more of the preceding or following aspects, or in the alternative to some aspects, the image generation circuit can be configured to superimpose the wind loading requirement on a portion of the image of the fenestration location and superimpose a wind loading rating of the replacement fenestration on the image of the replacement fenestration.

In a tenth aspect, in addition to one or more of the preceding or following aspects, or in the alternative to some aspects, the system can be or include a mobile coastal fenestration product system.

In an eleventh aspect, in addition to one or more of the preceding or following aspects, or in the alternative to some aspects, the coastal fenestration product system can be configured to load a project file from a non-volatile memory, the project file including a project geolocation, and cross-reference the project geolocation against a present geolocation as indicated by the geolocation circuit.

In a twelfth aspect, in addition to one or more of the preceding or following aspects, or in the alternative to some aspects, the coastal fenestration product system can be configured to issue a notice to the system user if the project geolocation does not match the present geolocation.

In a thirteenth aspect, in addition to one or more of the preceding or following aspects, or in the alternative to some aspects, the geolocation circuit can include a satellite signal receiver.

In a fourteenth aspect, in addition to one or more of the preceding or following aspects, or in the alternative to some aspects, the coastal fenestration product system can be configured to generate a regulatory output listing regulatory requirements and wind loading levels for the one or more fenestrations of the building.

In a fifteenth aspect, in addition to one or more of the preceding or following aspects, or in the alternative to some aspects, the coastal fenestration product system can be configured to transmit the regulatory output to a regulatory authority.

In a sixteenth aspect, in addition to one or more of the preceding or following aspects, or in the alternative to some aspects, the input can include one or more of fenestration unit size, fenestration proximity to a building corner, average building height, building category, and fenestration exposure.

In a seventeenth aspect, in addition to one or more of the preceding or following aspects, or in the alternative to some aspects, the building can be a residential building.

In an eighteenth aspect, in addition to one or more of the preceding or following aspects, or in the alternative to some aspects, the building can be a commercial building.

In a nineteenth aspect, in addition to one or more of the preceding or following aspects, or in the alternative to some aspects, the one or more fenestrations can include windows and/or doors.

In a twentieth aspect, in addition to one or more of the preceding or following aspects, or in the alternative to some aspects, the system user can include at least one selected from the group consisting of a building contractor, a building project sales professional, a building product consultant, an architect, and a building inspector.

In a twenty-first aspect, a method for operating a coastal fenestration product system is included. The method can include receiving input from a system user into the system regarding a building and fenestration locations therein, determining a wind speed zone with the system based on the geolocation of the building, determining a wind loading requirement level with the system for one or more fenestration locations of the building based on the input from the system user and the determined wind speed zone, and identifying a selected fenestration with the system as having a sufficient or insufficient wind loading rating with respect to the determined wind loading requirement level.

In a twenty-second aspect, in addition to one or more of the preceding or following aspects, or in the alternative to some aspects, the method can further include identifying a wind loading rating of one or more fenestrations for installation in the building.

In a twenty-third aspect, in addition to one or more of the preceding or following aspects, or in the alternative to some aspects, the method can further include generating an output for a visual user interface displaying the wind loading requirement level for one or more fenestrations of the building and a wind loading rating of a replacement fenestration.

In a twenty-fourth aspect, in addition to one or more of the preceding or following aspects, or in the alternative to some aspects, wherein generating an output for a visual user interface displaying the wind loading requirement level for one or more fenestrations of the building and a wind loading rating of a replacement fenestration includes configuring the output based on a role identity of the system user.

In a twenty-fifth aspect, in addition to one or more of the preceding or following aspects, or in the alternative to some aspects, wherein generating an output for a visual user interface displaying the wind loading requirement level for one or more fenestrations of the building and a wind loading rating of a replacement fenestration includes generating an image of a fenestration location of the building with an image of a replacement fenestration superimposed thereon.

In a twenty-sixth aspect, in addition to one or more of the preceding or following aspects, or in the alternative to some aspects, wherein generating an image of a fenestration location of the building with an image of a replacement fenestration superimposed thereon includes superimposing the wind loading requirement on a portion of the image of the fenestration location and superimposing a wind loading rating of the replacement fenestration on the image of the replacement fenestration.

In a twenty-seventh aspect, in addition to one or more of the preceding or following aspects, or in the alternative to some aspects, the method can further include loading a project file from a non-volatile memory, the project file including a project geolocation, and cross-referencing the project geolocation against a present geolocation as indicated by the geolocation circuit.

In a twenty-eighth aspect, in addition to one or more of the preceding or following aspects, or in the alternative to some aspects, the method can further include generating a regulatory output listing regulatory requirements and wind loading levels for the one or more fenestrations of the building.

In a twenty-ninth aspect, in addition to one or more of the preceding or following aspects, or in the alternative to some aspects, wherein generating a regulatory output listing regulatory requirements and wind loading levels for the one or more fenestrations of the building includes transmitting the regulatory output to a regulatory authority.

In a thirtieth aspect, in addition to one or more of the preceding or following aspects, or in the alternative to some aspects, the input from the system user regarding the building and fenestration locations therein includes at least one of an average roof height of the building, an exposure of the fenestration locations, a proximity of the fenestration locations to a corner of the building, a size of the fenestration locations, and a category of the building.

In a thirty-first aspect, in addition to one or more of the preceding or following aspects, or in the alternative to some aspects, the method can further include calculating a proximity to an adjacent wind speed zone.

In a thirty-second aspect, in addition to one or more of the preceding or following aspects, or in the alternative to some aspects, the building can be a residential building.

In a thirty-third aspect, in addition to one or more of the preceding or following aspects, or in the alternative to some aspects, the building can be a commercial building.

In a thirty-fourth aspect, in addition to one or more of the preceding or following aspects, or in the alternative to some aspects, the one or more fenestration locations include openings for windows and/or doors.

In a thirty-fifth aspect, in addition to one or more of the preceding or following aspects, or in the alternative to some aspects, the system user can include at least one selected from the group consisting of a building contractor, a building project sales professional, a building product consultant, an architect, and a building inspector.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of wind zones in accordance with various embodiments herein.

FIG. 2 is a schematic view of a coastal fenestration product system in accordance with various embodiments herein.

FIG. 3 is a diagram of building site factors in accordance with various embodiments herein.

FIG. 4 is a schematic view of performance requirement factors in accordance with various embodiments herein.

FIG. 5 is a schematic view of a coastal fenestration product system in accordance with various embodiments herein.

FIG. 6 is a schematic view of a coastal fenestration product system in accordance with various embodiments herein.

FIG. 7 is a schematic view of a regulatory output in accordance with various embodiments herein.

FIG. 8 is a schematic view of project interface in accordance with various embodiments herein.

FIG. 9 is a schematic view of a map interface in accordance with various embodiments herein.

FIG. 10 is a schematic view of a product selection interface in accordance with various embodiments herein.

FIG. 11 is a schematic view of a wall and a fenestration unit in accordance with various embodiments herein.

FIG. 12 is a schematic view of a wall and a fenestration unit in accordance with various embodiments herein.

FIG. 13 is a schematic view of a wall and a fenestration unit in accordance with various embodiments herein.

FIG. 14 is a schematic block diagram of components of a system in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, building codes and other regulations dictate specific performance levels related to wind loading and impact resistance for fenestrations in coastal areas based on the wind zone of the geolocation of the building into which the fenestrations will be installed. However, fenestration models can vary widely in their actual performance levels with respect to high wind loads and flying projectiles. This can make it challenging to select appropriate fenestrations for a given building while making both the required performance levels (as dictated by building code and other regulations) and the actual or rated performance levels of specific fenestrations clear for stakeholders including product consultants, building owners, and regulatory authorities.

Embodiments herein can include coastal fenestration product systems configured to receive an input from a system user regarding the building and fenestration locations therein and determine a required performance level and/or required impact resistance level for one or more fenestrations of the building as dictated by building code and other regulations based on the input from the system user and the geolocation of the building. Coastal fenestration product systems herein can also aid in selection fenestration models that exhibit actual or rated performance levels that satisfy the required performance levels.

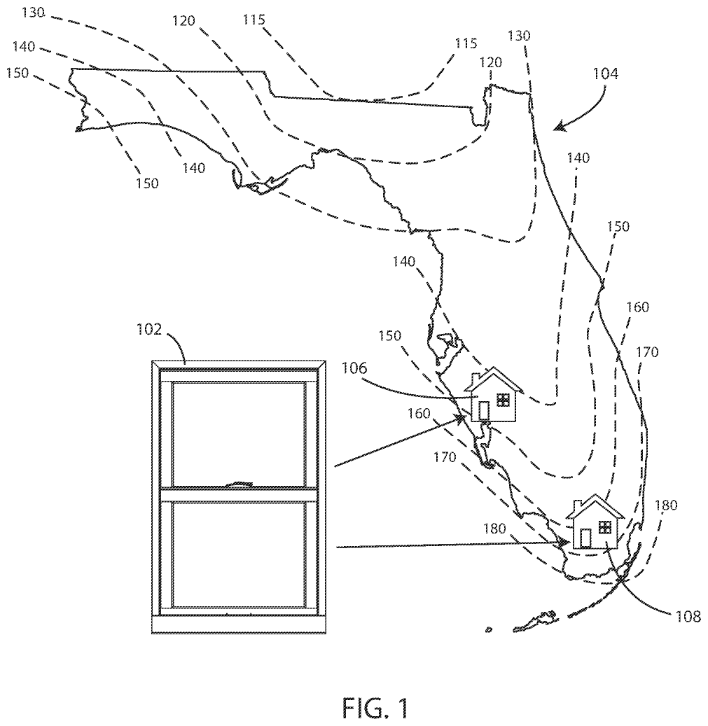

Referring now to FIG. 1, a schematic view is shown of wind zones 104 in accordance with various embodiments herein. In this example, the wind zones 104 are shown with respect to the state of Florida. However, it will be appreciated that special requirements for fenestrations occur in other states as well. FIG. 1 also shows a first building geolocation 106 and a second building geolocation 108. In this example, the first building geolocation 106 is in a first wind zone while the second building geolocation 108 is in a second wind zone. FIG. 1 also shows a fenestration unit 102. Performance requirements for the fenestration unit 102 will depend on whether it is to be installed in the first building geolocation 106 or the second building geolocation 108 and the respective wind zones thereof, amongst other factors. In various embodiments, coastal fenestration product systems herein can aid in determining the geolocation of a building into which a fenestration unit will be installed and determine the wind speed and/or wind zone thereof. In some embodiments, coastal fenestration product systems herein can be configured to calculate a proximity to an adjacent wind speed zone.

Current building codes in Florida require additional protection from wind-borne debris (impact resistance) in areas designated as a wind-borne debris region, which is currently defined as where wind speeds are greater than 140 mph or greater than 130 mph and within 1 mile of the coast (mean high water line), except for the Florida panhandle wherein the wind-borne debris region is defined to be those areas within 1 mile of the coast. Building geolocations within the high velocity hurricane zone (HVHZ—Miami-Dade and Broward counties) can be subject to additional performance requirements. In various embodiments, coastal fenestration product systems herein can aid in determining the geolocation of a building into which a fenestration unit will be installed and determine whether or not the geolocation of the building falls within a wind-borne debris region. In various embodiments, coastal fenestration product systems herein can aid in determining the distance of the geolocation of a building into which a fenestration unit will be installed from the coast and, specifically, whether it falls within 1 mile of the coast (mean high water line). In various embodiments, coastal fenestration product systems herein can aid in determining the geolocation of a building into which a fenestration unit will be installed and determine whether or not the geolocation of the building falls within the HVHZ.

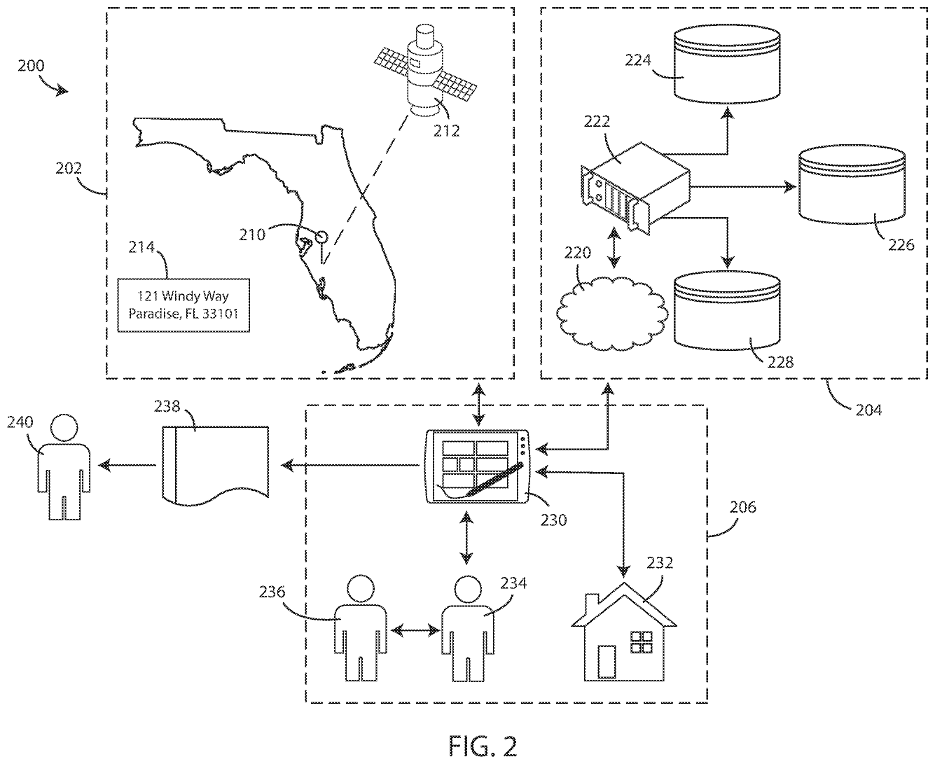

Coastal fenestration product systems herein can include various different components and subsystems. Referring now to FIG. 2, a schematic view of a coastal fenestration product system 200 is shown in accordance with various embodiments herein. FIG. 2 shows a geolocation input 202, a remote computing architecture 204, and a building geolocation 206.

At the building geolocation 206, a building 232 is shown along with a product consultant 234 and a customer 236. The building 232 can be of various types. For example, the building 232 can be a residential building, a commercial building (including light commercial), or the like. The product consultant 234 and/or the customer 236 can interface with the system through a user input and display unit 230. The user input and display unit 230 can be used to receive inputs from the product consultant 234 and/or the customer 236 as well as display information to the same. In various embodiments, the user input and display unit 230 can be mobile so that this part of the system can be brought to the building geolocation 206. Further details of exemplary user input and display units 230 are provided below.

The building 232 can include a plurality of fenestrations thereon. Fenestrations herein can include fenestrations of all types including, but not limited to, windows, doors (including patio doors and entry doors), and the like. In the context of a fenestration replacement scenario, a number of the fenestrations could be candidates for replacement. In the context of new construction, many fenestrations will typically be installed. The system 200 herein can be configured to determine the specific performance requirements (such as DP, PG, and/or impact resistance rating or standard) for each fenestration (as the requirements could vary by individual fenestration on a particular building) on the building 232 as well as guide selection of fenestration units that meet the performance requirements.

The geolocation input 202 can be used to determine a geolocation of the building (“a determined geolocation 210”) into which fenestration units will be installed. The geolocation input 202 can be provided by a geolocation circuit of the system described below in greater detail. In some embodiments, the geolocation circuit can include and/or can be in electronic communication with a satellite signal receiver so that the geolocation circuit can determine geolocation based on signals from a satellite 212. For example, the geolocation circuit can be part of a user input and display unit 230 that can be taken to the building site and the geolocation can be determined based on satellite signals. In other instances, a system user, such as a product consultant 234 can enter an address into the user input and display unit 230 or another device and the geolocation address 214 can be used to derive a geolocation in coordinates. Beyond a product consultant, system users herein can include, but are not limited to, building contractors, building project sales professionals, architects, building inspectors, building owners, building project customers, and the like. In some embodiments the address can be submitted to the cloud 220 via an address as a query (in JSON or another format such as XML) to a geolocation API (such as the Google Geocoding API) and the geolocation can be obtained via a response (in JSON or another format such as XML).

The remote architecture 204 can include various components that are accessed through and/or disposed in the cloud 220. As such, while FIG. 2 shows components separate from the cloud 220, it will be appreciated that these components can be within the cloud 220 or accessed through the cloud 220. The remote architecture 204 can include one or more servers 222 that can be real or virtual. The remote architecture 204 can include one or more databases. For example, the databases can include a wind zone database 224, a requirements database 226, and a product characteristic database 228, amongst others.

Using the building geolocation obtained, the determined geolocation 210, the system 200 can look up the wind zone and/or wind speed for the building 232 in the wind zone database 224. The wind zone and/or wind speed is a key element in determining the required performance levels for fenestration units on the building 232. However, the wind zone and/or wind speed is not the only factor in determining required performance levels for the fenestration units on the building 232. As such, the system 200 can be configured to receive an input from a system user regarding the building 232 and fenestration locations therein and determine a required performance level for one or more fenestrations of the building 232 based on the input from the system user and the geolocation 202 of the building 232. For example, the product consultant 234 can enter various pieces of information that can be used to determine performance requirements for individual fenestration units on the building 232 into the user input and display unit 230. Such additional pieces of information are described in greater detail below.

The requirements database 226 can store data allowing the system to determine a required level of performance for one or more fenestrations of the building based on the input from the system user and the geolocation of the building. By way of example, the requirements database 226 can store information similar to that found in Table R301.2(2) of the Florida Building Code (2020 FBC—Residential, 7^{th} Edition) relating design wind speeds (V_{ULT}) in mph, effective wind areas (in ft2), zone, roof parameters, and exposure to specific required levels of performance in terms of DP and/or DR negative and positive values). The requirements database 226 can also include adjustment coefficients similar to that found in Table R301.2(3) of the Florida Building Code relating exposure categories, mean roof height and adjustment coefficients which can be applied as an adjustment to convert nominal required performance levels to final required performance levels. Other pieces of data can also be stored in the requirements database 226 including other information required in the Florida Building Code, or other sources of reference information for calculating required performance levels.

Compliance with building codes is typically ensured through a construction permitting process. A permit must initially be obtained for the work to be done and then, after the work has been completed, an inspection must be completed by a building inspector 240 who inspects details of the project to ensure that building code and other requirements have been met. Inspection can be a tedious process and requires information on the requirements that must be met (e.g., performance requirements) as well as information on the details of the project that has been completed including fenestration units that have been installed and their actual or rated performance levels. In various embodiments herein, the system 200 can ease the inspection process by creating a regulatory output 238 that can be provided to, or otherwise shared with, the building inspector 240 or another representative of the applicable regulatory authority. The regulatory output 238 can be used to conveniently provide information on the required performance levels for fenestrations on the building as well as the actual or rated performance levels of fenestrations that have been installed. Further details of exemplary regulatory outputs are described in greater detail below.

While FIG. 2 illustrates the product consultant 234 directly interfacing with the system 200, it will be appreciated that the system 200 can also be configured to be directly interfaced with by the user input and display unit 230. In some embodiments, to allow a focus on information that is most relevant to an individual depending on their role, the information presented through the user interface of the user input and display unit 230 can be changed based on the role of the individual using the system. As such, in various embodiments herein, the output for the visual user interface can be configured based on a role identity of the system user. Examples of this are provided in greater detail below.

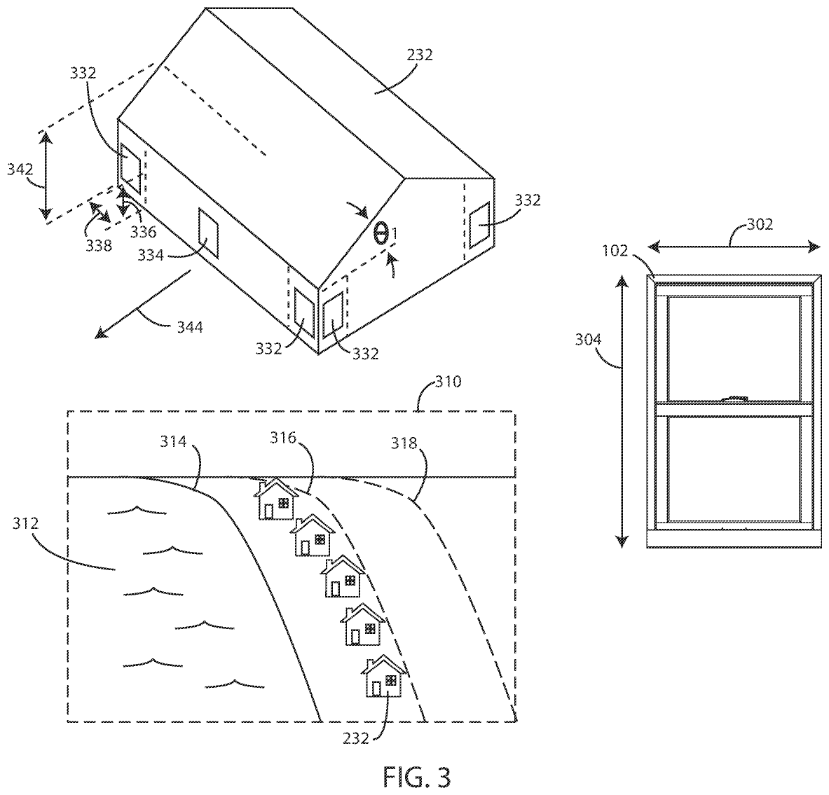

As referenced above, there are other factors that contribute to the performance requirements (e.g., required performance levels) of a particular fenestration on a building beyond wind zone. Referring now to FIG. 3, a diagram is shown of building site factors that can be accounted for by systems herein in accordance with various embodiments herein. In this diagram, a fenestration 102 is shown having a width 302 and a height 304. The surface area of the fenestration 102 as determined by width 302 and a height 304 impacts the performance characteristics of the fenestration 102. Further, the surface area of the rough opening (aperture in the wall of the building into which the fenestration 102 will be placed) impacts the performance requirements of the fenestration 102.

In this diagram, a building 232 is shown to include multiple fenestration units including corner fenestrations 332 and central wall fenestrations 334. There are many parameters of the building 232 that can be relevant for determining performance requirements of fenestrations thereof. In this illustration, the building 232 also includes an average building/roof height 342 along with a roof pitch or angle Θ1. The fenestration unit 102 also includes a fenestration elevation 336. The fenestration unit 102 also includes a distance from adjacent corner 338. The building 232 also has an exposure 344 level that can be described as an exposure category as defined in building codes. By way of example, exposure category “B” refers to “Urban and Suburban areas, wooded areas, or other terrain with numerous closely spaced obstructions having the size of single-family dwellings or larger.” In contrast, exposure category “C” refers to “the area which lies within 1500 feet of the coast construction control line, or within 1500 feet of the mean high tide line, whichever is less” except in the high velocity hurricane zone (HVHZ—Miami-Dade and Broward counties). As such, the building setting 310, and specifically the distance to the coast, can also impact fenestration performance requirements as it can impact the exposure category. The building setting 310 shown in FIG. 3 includes water 312 and a mean high tide line 314 or seasonal high-water line. The building setting 310 also includes a first shore zone line 316 based on a distance from the mean high tide line 314. The first shore zone limit 316 can be, for example, 600 feet from the mean high tide line 314. The building setting 310 also includes a second shore zone line 318 based on a distance from the mean high tide line 314. The second shore zone limit 318 can be, for example, 1500 feet from the mean high tide line 314.

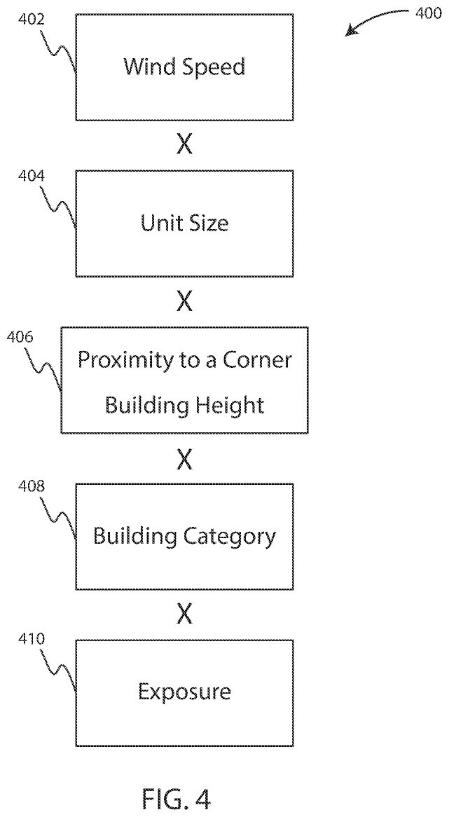

Referring now to FIG. 4, a schematic view is shown of factors 400 that impact required performance levels in accordance with various embodiments herein. A first factor is a wind speed 402 at the building geolocation. A second factor is a fenestration unit size 404. A third factor is a corner proximity (such as within 4 feet of a building corner) along with average roof height 406. A fourth factor is a building category 408. A fifth factor is a fenestration exposure 410 (described further elsewhere herein). Using these factors, the required performance levels for a fenestration unit can be derived. In various embodiments, a user input to the system can include one or more of fenestration unit size, fenestration proximity to a building corner, average roof height, building category, and fenestration exposure. However, in various embodiments, one or more factors can be automatically determined by the system such the wind speed 402. The wind speed 402 can be automatically determined using the geolocation of the building and then looking up the same in the wind zone database 224 or another database or through interface with an API providing wind speeds for specific geolocation coordinates or addresses. In some embodiments, other factors can also be determined by the system such as the fenestration unit size 404, fenestration proximity to a building 232 corner, average building height 342, building category 408, and fenestration exposure 410. The factors, once obtained either through user input or automatically, can then be used to lookup the required performance levels for the fenestration(s) in the requirements database 226 or another database or through interface with an API.

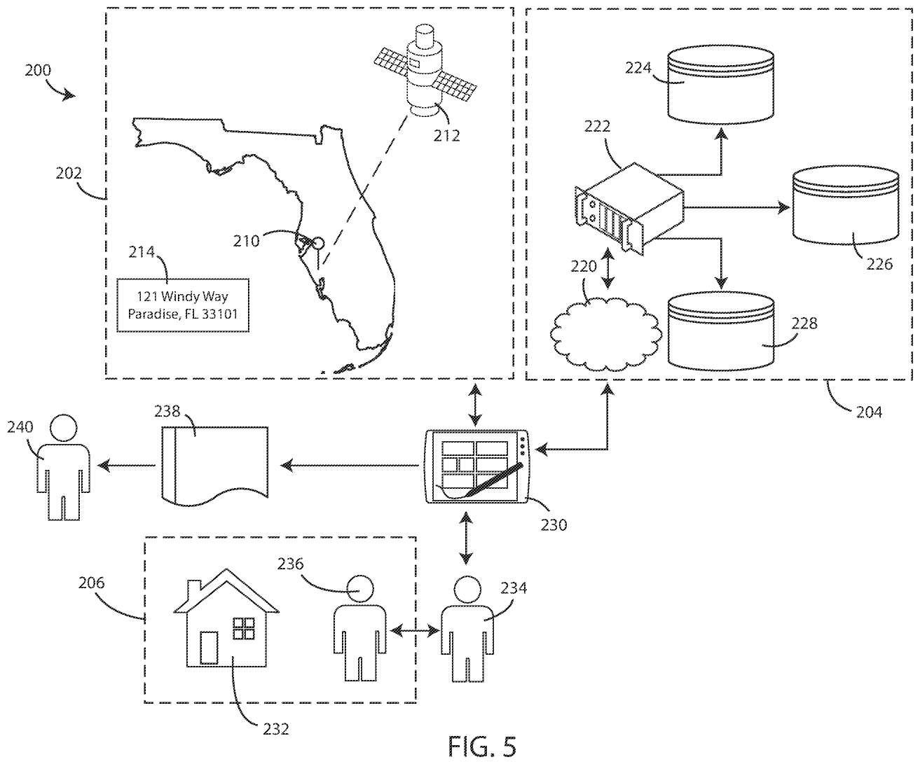

Referring now to FIG. 5, a schematic view of a coastal fenestration product system is shown in accordance with various embodiments herein. The system shown in FIG. 5 is generally similar to the system shown in FIG. 2. However, in this example, the product consultant 234 is not located at the building geolocation 206. Rather, the product consultant 234 may be at a remote site, such as their office or another location. In this scenario, it is advantageous for the system 200 (and can prevent errors) to not use the wind zone of wherever the product consultant 234 is currently located to calculate fenestration performance requirements (e.g., not use the current location of the product consultant 234, which in this example is away from the building geolocation 206). This can be done in various ways. In some embodiments, the coastal fenestration product system can be configured to load a project file from a non-volatile memory, the project file including a project geolocation, and cross-reference the project geolocation against a present geolocation as indicated by the geolocation circuit. In various embodiments, the coastal fenestration product system can be configured to issue a notice to the system user if the project geolocation does not match the present geolocation. In some embodiments, the system can store work locations of the product consultant 234 and, if the system detects that a present geolocation matches a work location of the product consultant 234, and no project address/geolocation is already stored in the system, then query the system user (such as the product consultant 234) for the correct address and/or coordinates of the building for which the project pertains.

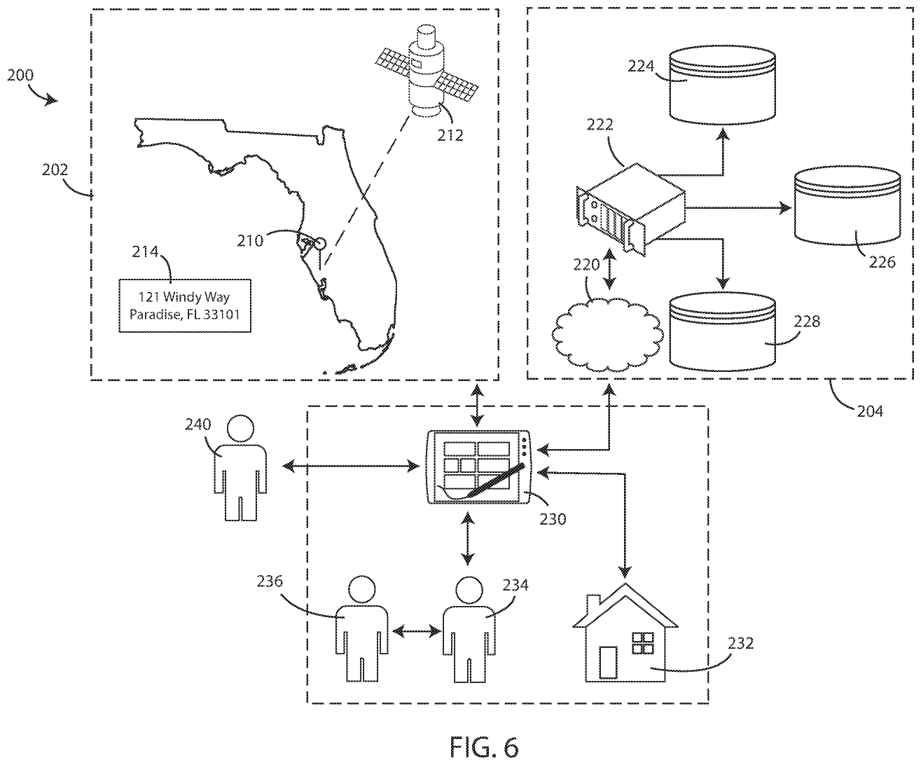

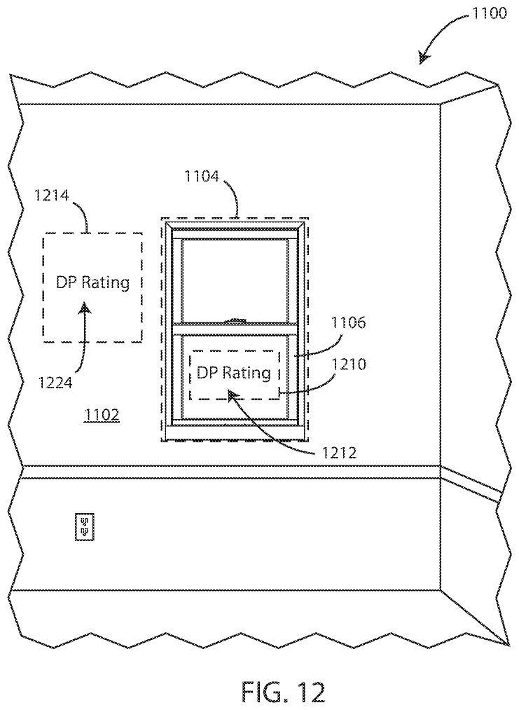

Referring now to FIG. 6, a schematic view of a coastal fenestration product system is shown in accordance with various embodiments herein. The system shown in FIG. 6 is generally similar to the system shown in FIG. 2. However, in this embodiment, the building inspector 240 can interface directly with the system 200. In some embodiments, the building inspector 240 can interface with the system using a workstation, a tablet computing device, a smart phone, or the like. The building inspector 240 can interface with the device to obtain information that would be a part of the regulatory output 238. In some embodiments, the building inspector 240 can also interface with the system 200 to check information that may not be a part of the regulatory output 238. In some embodiments, the regulatory inspector 240 can use the system to access a view of the fenestrations in the project similar to that shown below in FIG. 12 wherein information about the project (such as information about the fenestrations installed therein and actual or rated performance of the same, information about the required levels of performance of fenestrations, and the like) can be superimposed on the view to create an enhanced and/or augmented reality view for the building inspector 240. In some embodiments, the system 200 can facilitate the building inspector 240 inspecting the project such that the permit can be cleared without the building inspector 240 being at the geolocation of the building where the fenestrations are installed.

In various embodiments, the coastal fenestration product system can be configured to generate a regulatory output 238 listing one or more of regulatory requirements (including required performance levels), calculated wind loading levels at the geolocation of the building, actual or rated performance levels for fenestrations of the building 232, and other data for the one or more fenestrations of the building 232. In various embodiments, the coastal fenestration product system can be configured to transmit the regulatory output 238 to a regulatory authority and/or a building inspector or similar individual.

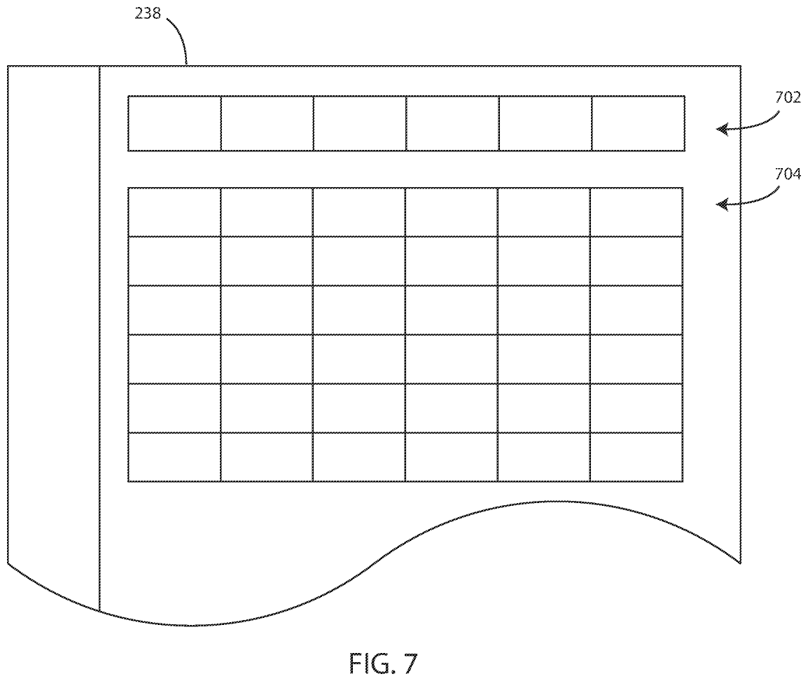

Referring now to FIG. 7, a schematic view of an exemplary regulatory output 238 is shown in accordance with various embodiments herein. The regulatory output 238 can include site-specific conditions 702 and other data related to the building and calculations made regarding performance requirements. In some embodiments, the site-specific conditions 702 can include one or more of the ASCE standard used (e.g., ASCE/SEI 7-10, ASCE/SEI 7-16, etc.), wind zone of the geolocation of the building, exposure category of the building, mean roof height of the building, Kz value (exposure coefficient), risk category of the building, and whether or not the building is in a wind-borne debris region. The regulatory output 238 can also include individual fenestration unit calculations 704. Data displayed for individual fenestration unit calculations 704 can include one or more of a fenestration ID (to distinguish one fenestration on a building from another), fenestration room (e.g., basement, bedroom, kitchen, etc. where the fenestration is located), fenestration product type (e.g., double hung window, casement window, awning window, patio door, etc.), fenestration unit size (e.g., height and width), fenestration unit area (e.g., the product of height and width), the wind zone of the building, GCp (external pressure coefficient), actual or rated performance levels of the fenestrations such as actual unit DP (“design pressure”, negative and positive pressures, wherein such pressures refer to a differential pressure across the fenestration exterior to interior with positive pressures acting inward and negative pressures acting outward on the fenestration), actual or rated performance levels of the fenestrations such as actual unit PG (“performance grade”, reflecting a pressure value at which all of air infiltration, water, and structural loading components are met), required fenestration unit performance levels (negative and positive pressure requirements as required by building codes or other regulations determined as described herein), whether or not the fenestration unit is being installed in a wind-borne debris region, and the regulatory approval number of the fenestration unit (such as a Florida approval number). References to pressure herein shall be in units of pounds per square foot (PSF) unless specified otherwise.

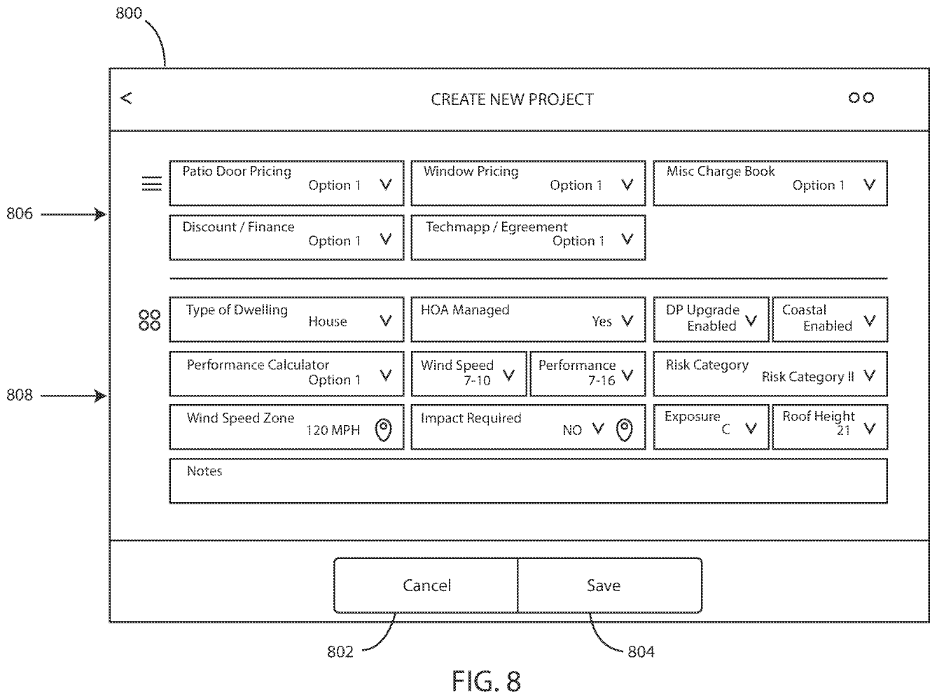

In various embodiments, the system can display a project interface to a system user, such as through the user input and display unit 230 thereof. Referring now to FIG. 8, a schematic view of project file interface 800 is shown in accordance with various embodiments herein. The project file interface 800 includes a first interface object 802, such as a “cancel” button. The project file interface 800 also includes a second user interface object 804, such as a “save” button. The project file interface 800 can display configuration data 806. Configuration data can include, for example, fenestration pricing information, legal agreement versions for fenestration projects, discount information, and the like. The project file interface 800 also includes a building specific data 808. Building specific data 808 can include the type of dwelling, information regarding the performance calculations used, wind speed zone, wind speeds, required performance, whether or not impact resistance is needed, exposure category, mean roof height, building risk category, building geolocation, and the like.

In various embodiments, the project file interface 800 can also include a user interface object 804 in the form of a “load” button to load an existing project from memory. In various embodiments, the coastal fenestration product system can be configured to load a project file from a non-volatile memory, the project file including a project geolocation 202, and cross-reference the project geolocation 202 against a present geolocation 202 as indicated by the geolocation 202 circuit. In various embodiments, the coastal fenestration product system can be configured to issue a notice to the system user if the project geolocation 202 does not match the present geolocation 202. In some embodiments, the notice to the system user can take the form of a pop-up message on the user interface. In other embodiments, the notice to the user can take the form of a change in color of a certain field on the user interface.

In various embodiments herein, the output for the visual user interface can be configured based on a role identity of the system user. For example, in the context of FIG. 8, only a product consultant 234 can be authorized to create new and/or modify existing projects. As such, in various embodiments, if the system determines that the system user is in the role of a customer 236 or building inspector 240, then the user interface described with reference to FIG. 8 can be disabled.

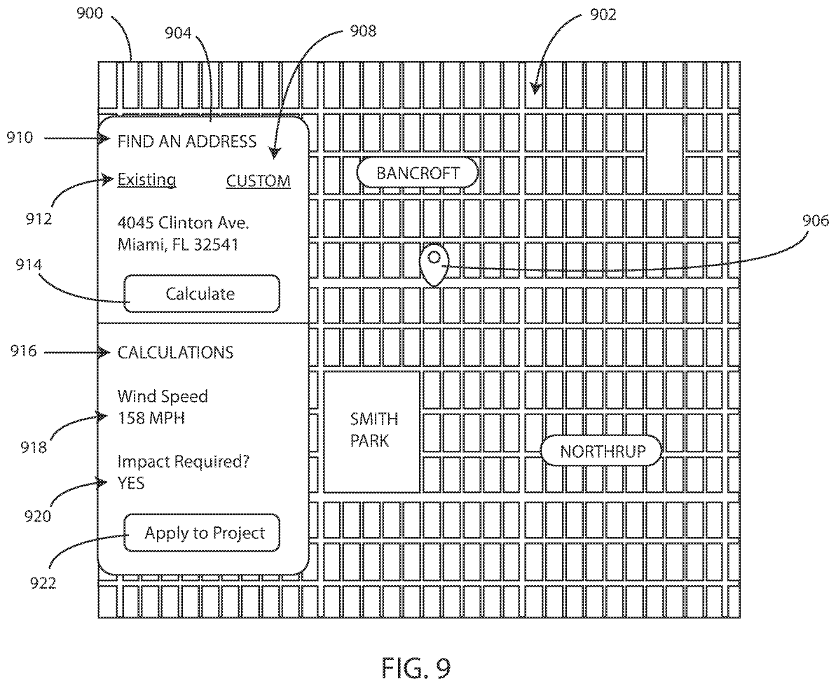

In various embodiments, the system can display a geolocation interface to a system user, such as through the user input and display unit 230 thereof. Referring now to FIG. 9, a schematic view of a geolocation interface 900 is shown in accordance with various embodiments herein. The geolocation interface 900 includes a map 902. The geolocation interface 900 also includes a geolocation query 910. The geolocation interface 900 also includes an area to show the results of calculations 916 associated with a geolocation, such as the wind speed and/or wind speed zone of the geolocation, whether or not the geolocation is in a zone requiring impact resistance, and the like. The geolocation interface 900 also includes a user interface object to apply the geolocation to the project 922. The map 902 includes a site location 906. The site location 906 can indicate where the system determines the building for fenestration installation to be located based on the address and/or geolocation coordinates. The geolocation query 910 includes a custom address option 908. The geolocation query 910 also includes an existing address option 912. The geolocation query 910 also includes a user interface object in the form of a calculation button 914 to use the geolocation and/or address for calculates related to required performance levels. For example, the address calculations 916 can include an address/location specific wind speed 918 and an address/location specific impact requirement 920.

In some embodiments, only a product consultant 234 can be authorized to change the address and/or geolocation of projects. As such, in various embodiments, if the system determines that the system user is in the role of a customer 236 or building inspector 240, then the user interface described with reference to FIG. 9 can be configured to disallow any changes to the address and/or geolocation of a given project.

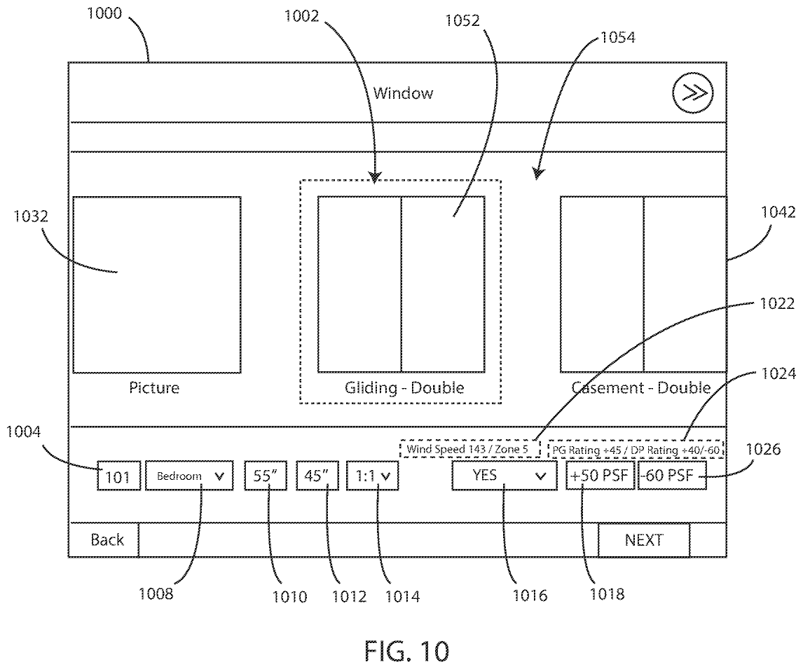

In various embodiments, the system can display a product selection interface to a system user, such as through the user input and display unit 230 thereof. Referring now to FIG. 10, a schematic view of an exemplary product selection interface 1000 is shown in accordance with various embodiments herein. The product selection interface 1000 includes a selected fenestration unit 1002, which can be a fenestration unit type, such as a gliding window, a double hung window, a casement window, or the like. The selected fenestration unit 1002 can be displayed or superimposed over a background 1054. The background 1054 can be a default background or, in some embodiments, herein can be an actual image of the building location into which a fenestration product will be installed. For example, the system user can take a photo of the building location and the same can be used for the background 1054. The product selection interface 1000 can also include alternative fenestration units, such as alternatives 1032 and 1042. The user input and display unit 230 can allow the system user to click on a fenestration unit type to select it.

In various embodiments, the system can limit display of fenestration products in product selection interface 1000 based on those that can potentially meet performance requirements for the geolocation of the building and the specific rough opening of the building into which the fenestration will be installed. For example, in some embodiments, fenestration products that cannot meet performance requirements (regardless of size and other options for that fenestration unit type—for example some window types may not be produced in a version meeting coastal impact requirements) will be omitted entirely from display in the product selection interface 1000. In some embodiments, fenestration products that cannot meet performance requirements (regardless of size and other options for that fenestration unit type) will be grayed out in the product selection interface 1000. In some embodiments, fenestration products that cannot meet performance requirements (regardless of size and other options for that fenestration unit type) will be shown in the product selection interface 1000 with a banner or other notice thereon to indicate that they do not meet performance requirements.

In various embodiments, the system can display special features or performance characteristics of fenestration products in the product selection interface 1000. For example, if a particular fenestration unit meets coastal impact requirements, then the same can be displayed with a banner 1052 or other visual interface object in the product selection interface 1000, such as superimposed over the image of the fenestration product or being displayed adjacent thereto.

The product selection interface 1000 also includes a unit ID 1004. In some embodiments, the unit ID can be assigned sequentially or otherwise and can be used to distinguish one fenestration in a project from another fenestration in the same project. The product selection interface 1000 can also include a fenestration room location 1008. The product selection interface 1000 can also include a fenestration width 1010. The product selection interface 1000 can also include a fenestration height 1012. The product selection interface 1000 can also include a sash ratio 1014. The product selection interface 1000 can also include a corner unit indicator 1016.

The product selection interface 1000 can also include a required fenestration positive pressure 1018 (e.g., part of required performance for the fenestration at the geolocation of the building). The product selection interface 1000 also includes a required fenestration negative pressure 1026 (e.g., part of required performance for the fenestration at the geolocation of the building). The product selection interface 1000 also includes a geolocation site wind speed and zone 1022. The product selection interface 1000 can also include the actual or rated performance of the currently selected fenestration 1024.

In various embodiments, the coastal fenestration product system can be configured to identify a selected fenestration as having sufficient or insufficient performance levels with respect to the required performance levels. For example, the fenestration positive pressure 1018 or the fenestration negative pressure 1026 of the selected fenestration can be visually displayed to indicate whether or not it meets required performance levels. In some embodiments, the actual or rated fenestration positive pressure 1018 and/or the actual or rated fenestration negative pressure 1026 can be displayed in a color to indicate whether or not they meet required performance levels, such as being displayed in green if the requirement is met or displayed in red if the requirement is not met. Thus, the color coding of 1018 and 1026 can indicate if the actual or rated performance of the selected fenestration product meets the required levels of performance.

The features of the product selection interface 1000 described with respect to FIG. 10 can be effective to simplify the selection process based on integrating user input, the performance requirements for fenestration units, and the actual or rated performance of units.

In some embodiments, only a single fenestration unit is selected at a time (such as shown in FIG. 10). However, other embodiments herein also can accommodate mulled combinations of individual fenestrations. For example, the system can calculate the requirements vs actual or rated performance for mulled combinations of individual fenestrations and/or the mull material used to join the individual fenestrations.

In some embodiments, only a product consultant 234 can be authorized to change fenestration selections. As such, in various embodiments, if the system determines that the system user is in the role of a customer 236 or building inspector 240, then the user interface described with reference to FIG. 10 can be configured to disallow any changes to selected fenestrations of a given project.

In various embodiments, the coastal fenestration product system can be configured to generate and/or display an augmented reality view including a real portion of a building where a fenestration unit will be installed along with a superimposed fenestration unit over the real portion of the building. This can allow for enhanced visualization of the fenestration in the context of the building into which it will be installed. In some embodiments, the required level of performance for the fenestration location and/or the actual or rated level of performance of the replacement fenestration can be superimposed as well. This can allow for a more intuitive display of such information. In some embodiments, aspects of the specific building such as outside views and/or internal style decor can be displayed in the view.

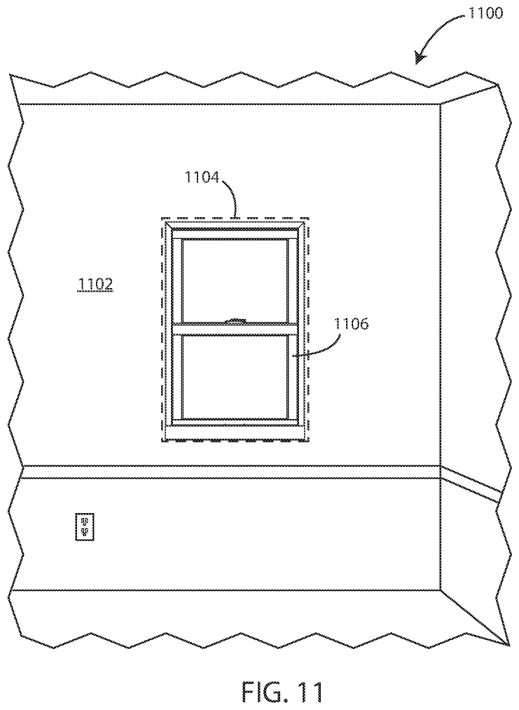

Referring now to FIG. 11, a schematic view of a wall and a fenestration unit is shown in accordance with various embodiments herein. The user input and display unit of the system can be configured to display a fenestration in-building view 1100. In this example, the fenestration in-building view 1100 includes a wall 1102 along with a superimposed segment 1104. The superimposed segment 1104 can define the border of that which is superimposed with, in this example, the area outside the superimposed segment 1104 reflecting an actual view of the building and/or room as may be taken using a camera of the user input and display unit. An image of a fenestration unit 1106 can be displayed within the superimposed segment 1104. As such, in various embodiments herein, an image generation circuit can be configured to generate an image of a fenestration location of the building 232 with an image of a replacement fenestration superimposed thereon.

As referred to above, in some embodiments, the required performance levels of the fenestration and/or the actual or rated performance level of the replacement fenestration can be superimposed over a real image of the building or room. Referring now to FIG. 12, a schematic view of a wall and a fenestration unit is shown in accordance with various embodiments herein. The user input and display unit of the system can be configured to display a fenestration in-building view 1100. In this example, the fenestration in-building view 1100 includes a wall 1102 along with a first superimposed segment 1104, a second superimposed segment 1210, and a third superimposed segment 1214. As before, an image of a fenestration unit 1106 can be displayed within the first superimposed segment 1104. However, in this example, the actual or rated performance levels 1212 of the replacement fenestration can be displayed in the second superimposed segment 1210, and the required performance levels 1224 for the fenestration location can be displayed in the third superimposed segment 1214. Thus, in various embodiments, the image generation circuit can be configured to superimpose the required performance levels (such as DP and/or DR values, etc.) on a portion of the image of the fenestration location and superimpose the actual or rated performance levels of the replacement fenestration on the image of the replacement fenestration.

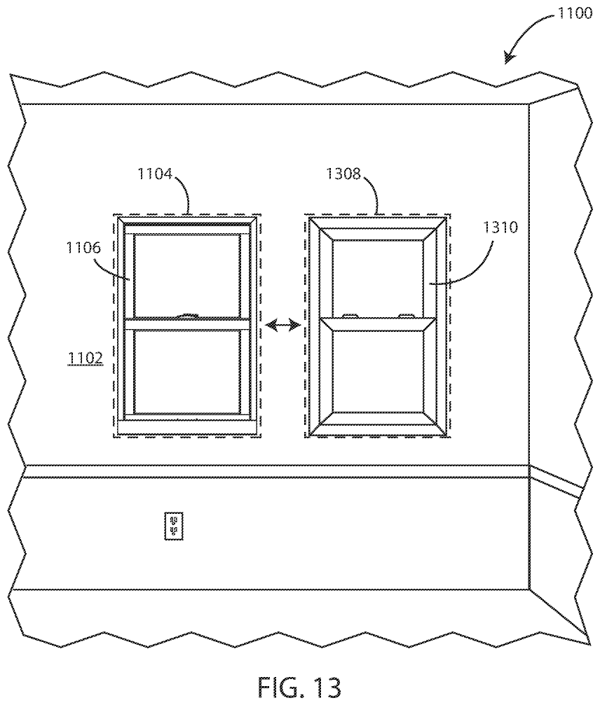

In some embodiments, more than one fenestration can be superimposed to allow a system user and/or a project customer to view different options of how fenestrations will look in place on the building and/or in a room thereof. Referring now to FIG. 13, a schematic view of a wall and a fenestration unit is shown in accordance with various embodiments herein. The fenestration in-building view 1100 includes a wall 1102 along with a first superimposed segment 1104 and a first superimposed fenestration unit 1106 therein along with a second superimposed segment 1308 and a second superimposed fenestration unit 1310 therein. In some embodiments, the first superimposed fenestration unit 1106 and the second superimposed fenestration unit 1310 can be fenestrations of different types, such as a double-hung window versus a casement window. In some embodiments, the first superimposed fenestration unit 1106 and the second superimposed fenestration unit 1310 can be fenestrations from different manufacturers showing, for example, different stylistic features and/or different site lines afforded by the different models.

While FIGS. 11-13 depict a view of a fenestration and the surrounding wall of a building as taken from the inside of the building, it will be appreciated that similar views from outside the building are also contemplated herein. Further, in embodiments where augmented reality views are contemplated, such as FIGS. 11-13, it will be appreciated that such views can be rendered on a user input and display unit herein including a camera (such as a tablet computing device or a smart phone), but also can be rendered on an augmented or mixed reality viewing device such as augmented or mixed reality goggles. As such, in some embodiments, the user input and display unit herein can be an augmented or mixed reality viewing device. The user input and display unit, or another device within the surrounding environment, can be equipped with various sensors including, but not limited to, laser sensors, ultrasonic sensors, directional sensors, mapping sensors, acoustic sensors, motion sensors, light sensors, and the like. Various other aspects of augmented reality systems are described in U.S. Pat. Appl. No. 2012/0113140, the content of which is herein incorporated by reference. In some embodiments, the system can receive dimension measurements (such as the width and/or height of a fenestration) from user input, but in other embodiments the system can measure such dimensions automatically. As such, dimensional measurements can be performed using inputs from various hardware components and/or sensors including, but not limited to, video inputs, laser sensors, ultrasonic sensors, acoustic sensors, and the like. One approach for measuring distances using a laser sensor is described in U.S. Pat. No. 7,283,214, the content of which is herein incorporated by reference.

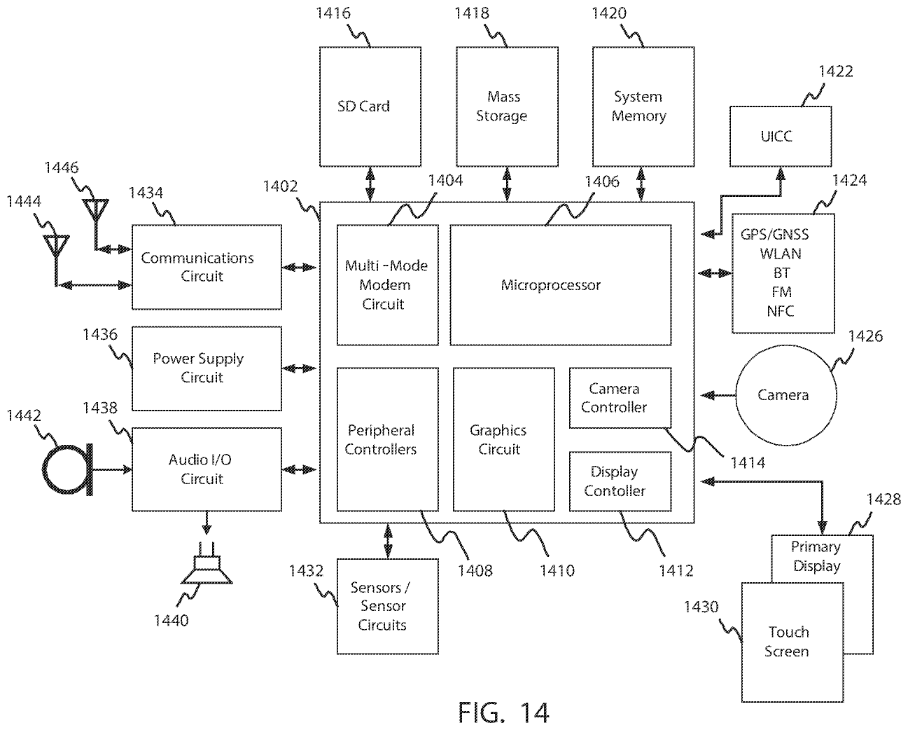

Referring now to FIG. 14, a schematic block diagram is shown of components of a system in accordance with various embodiments herein. This block diagram is just provided by way of illustration, and it will be appreciated that systems herein can include greater or lesser numbers of components (e.g., some components described can be omitted in some embodiments and other components can be added). The system in this example can include a control circuit 1402. The control circuit 1402 can include various components which may or may not be integrated. In various embodiments, the control circuit 1402 can include a microprocessor 1406, which could also be a microcontroller, FPGA, ASIC, or the like. The control circuit 1402 can also include a multi-mode modem circuit 1404 which can provide communications capability via various wired and wireless standards. The control circuit 1402 can include various peripheral controllers 1408. The control circuit 1402 can also include various sensors/sensor circuits 1432. Sensors herein can include, but are not limited to, temperature sensors, light sensors, photo sensors, accelerometers, and the like. The control circuit 1402 can also include a graphics circuit 1410 (including a GPU in some embodiments), a camera controller 1414, and a display controller 1412.

Graphics circuit 1410 can generate a 2D or 3D image based on information including one or more of geometry, viewpoint, texture, lighting and shading information, and the like. The term “graphics pipeline” or “view rendering pipeline” can be used to refer to the sequence of steps used to create a 2D raster representation of a 3D scene. The video processing circuit and/or GPU can execute one or more steps of the graphics pipeline. The graphics circuit and/or GPU can also include one or more physical components used in the graphics pipeline. Using the information described above, the graphics pipeline can include one or more stages of creating a scene out of geometric primitives, modelling and transformation, camera transformation, lighting, projection transformation, clipping, scan conversion or rasterization, and texturing and fragment shading. In various embodiments, other operations can also be performed. In various embodiments, the graphics pipeline can use OpenGL, DirectX, or other protocols. In embodiments herein including augmented reality views, the graphics circuit and/or GPU can be used to digitally superimpose images as described herein.

In various embodiments, the control circuit 1402 can interface with an SD card 1416, mass storage 1418, and system memory 1420. In various embodiments, the control circuit 1402 can interface with universal integrated circuit card (UICC) 1422. A geolocation circuit or spatial location determining circuit can be included and can take the form of an integrated circuit 1424 that can include components for receiving signals from GPS (such as a satellite signal receiver), GLONASS, BeiDou, Galileo, SBAS, WLAN, BT, FM, NFC type protocols, 5G picocells, or E911. In various embodiments, the system can include a camera 1426. In various embodiments, the control circuit 1402 can interface with a primary display 1428 that can also include a touch screen 1430. In various embodiments, an audio I/O circuit 1438 can interface with the control circuit 1402 as well as a microphone 1442 and a speaker 1440. In various embodiments, a power supply or power supply circuit 1436 can interface with the control circuit 1402 and/or various other circuits herein in order to provide power to the system. In various embodiments, a communications circuit 1434 can be in communication with the control circuit 1402 as well as one or more antennas (1444, 1446). In some embodiments, the components shown in FIG. 14 can be a part of the user input and display unit of the system described herein. In some embodiments, the components shown in FIG. 14 can be integrated as a single device. In some embodiments, the components shown in FIG. 14 can be distributed across two or more devices that are in electronic communication with one another.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method for operating a coastal fenestration product system is included, the method receiving input from a system user into the system regarding a building and fenestration locations therein, determining a wind speed zone with the system based on the geolocation of the building, determining required performance levels with the system for one or more fenestration locations of the building based on the input from the system user and the determined wind speed zone, and identifying a selected fenestration with the system as having a sufficient or insufficient performance levels with respect to the determined required performance levels.

In an embodiment, the method can further include identifying a required performance level of one or more fenestrations for installation in the building.

In an embodiment, the method can further include generating an output for a visual user interface displaying the required performance level for one or more fenestrations of the building and the actual or rated performance level of a replacement fenestration.

In an embodiment of the method, generating an output for a visual user interface displaying the required performance level for one or more fenestrations of the building and an actual or rated performance level of a replacement fenestration further comprises configuring the output based on a role identity of the system user.

In an embodiment of the method, generating an output for a visual user interface displaying the required performance level for one or more fenestrations of the building and the actual or rated performance level of a replacement fenestration further comprises generating an image of a fenestration location of the building with an image of a replacement fenestration superimposed thereon.

In an embodiment of the method, generating an image of a fenestration location of the building with an image of a replacement fenestration superimposed thereon further comprises superimposing the required performance levels on a portion of the image of the fenestration location and superimposing the actual or rated performance levels of the replacement fenestration on the image of the replacement fenestration.

In an embodiment, the method can further include loading a project file from a non-volatile memory, the project file including a project geolocation, and cross-referencing the project geolocation against a present geolocation as indicated by the geolocation circuit.

In an embodiment, the method can further include generating a regulatory output listing required performance levels and actual or rated performance levels for the one or more fenestrations of the building.

In an embodiment of the method, generating a regulatory output listing required performance levels and actual or rated performance levels for the one or more fenestrations of the building further comprises transmitting the regulatory output to a regulatory authority.

In an embodiment of the method, the input from the system user regarding the building and fenestration locations therein comprises at least one of an average roof height of the building, an exposure of the fenestration locations, a proximity of the fenestration locations to a corner of the building, a size of the fenestration locations, and a category of the building.

In an embodiment, the method can further include calculating a proximity to an adjacent wind speed zone.

### Performance Requirements/Characteristics

Various building codes require buildings to withstand wind forces resulting from design wind speeds at a given building geolocation. The design wind speeds can be determined based on geolocation and reference to a database including the information regarding wind speeds and zones as visually depicted in FIG. 1. Such building codes also require protection (such as impact resistance) from wind-borne debris wind-borne debris regions (described above).

Requirements for fenestrations at a given geolocation as well as the actual performance of fenestrations can be quoted as design pressure (or DP). DP can include both negative and positive pressure values, wherein such pressure values refer to a differential pressure across the fenestration exterior to interior with positive pressures acting inward and negative pressures acting outward on the fenestration. In various embodiments, the actual performance of fenestrations can also be quoted as a performance grade (or PG), reflecting a pressure value (negative and positive values) at which all of air infiltration, water, and structural loading components are met.

In some embodiments, the system can calculate expected wind loads or differential pressure across a fenestration at a given geolocation beginning with the Ensewiler Formula where P=0.00256×V², where V equals the wind speed or velocity in MPH at the given geolocation and P equals the differential pressure across the fenestration in pounds per square foot (PSF).

In some embodiments, the system can calculate design wind pressure using the methodology of the wind load provisions of ASCE 7-16, which provides two methods for wind load calculation including a simplified procedure and an analytical procedure. By way of example, design wind pressure can be calculated as described at 2.1 of ASCE 7-16 for a building 60 feet or lower using the equation P=qh[(GCp)−(GCpi)] wherein qh is velocity pressure at mean roof height h above ground, GCp is external pressure coefficient, and GCpi is internal pressure coefficient. In some embodiments, the system herein can allow the system user to choose a standard for calculation of design wind pressure including, for example, ASCE 7-16 or ASCE 7-10. The calculated design wind pressure can then be used in combination with the data stored in the requirements database to determine required performance levels for fenestrations.

In some embodiments, the system can be configured to determine required performance levels for fenestrations based on the input from the system user and the geolocation of the building providing wind speed data and then using the methodology described in R301 of the Florida Building Code (2020 FBC—Residential, 7^{th} Edition). In specific, design wind speeds (V_{ULT}) in mph can be considered along with effective wind areas (in ft2), zone, roof parameters, and exposure to determine specific required levels of performance in terms of DP and/or DR negative and positive values) as provided in Table R301.2(2) of the Florida Building Code (2020 FBC—Residential, 7^{th} Edition). The system can also apply adjustment coefficients similar to that found in Table R301.2(3) of the Florida Building Code relating exposure categories, mean roof height and adjustment coefficients to convert nominal required performance levels to final required performance levels by multiplying by the adjustment coefficient. Ultimate design wind speed (V_{ULT}) can be determined in accordance with section R301.2.1 of the Florida Building Code (2020 FBC—Residential, 7^{th} Edition), the content of which is herein incorporated by reference in its entirety. Nominal design wind speeds can be converted to ultimate design wind speeds using the conversions provided in Table R301.2.1.3 of the Florida Building Code (2020 FBC—Residential, 7^{th} Edition). Other techniques of determining required performance levels are also contemplated herein.

In various embodiments herein, the system can be configured to determine which standards must be met based on geolocation as well as other inputs (user inputs or automatically determined inputs). In some embodiments, the system can be configured to determine which standards must be met based on geolocation such as ASTM E1996-17 and/or Florida TAS Standards. In some embodiments, the system can be configured to determine whether a fenestration unit must withstand the impact of a large projectile, such as in the ASTM/E1886-19/E1996-17 large missile test or TAS 201 and/or 203 large missile test for High Velocity Hurricane Zone based on geolocation. In some embodiments, system can determine whether a fenestration unit must withstand the impact of projectiles according to ASTM E1886-19 missile levels A, B, C, D, and/or E. In some embodiments, the system can determine whether a fenestration unit at a given geolocation must meet performance requirements as specified by TAS 202-94, such as may be required in high-velocity hurricane zones. In some embodiments, the system can determine whether a fenestration unit at a given geolocation must meet High-Velocity Hurricane Zones (HVHZ) Wind Zone 4 impact resistance properties. In some embodiments, the system can determine whether a fenestration unit at a given geolocation must meet performance requirements as specified in AAMA/WDMA/CSA 101/I.S.2/A440-2017.

Beyond performance related to wind loading and impact resistance requirements for fenestrations, embodiments herein can also be used in the context of energy efficiency requirements. Energy efficiency requirements can be analogous to some aspects of performance related to wind loading or impact resistance requirements in that they can be geolocation specific. As such, in various embodiments herein a fenestration product system can be included having a control circuit and a geolocation circuit, wherein the geolocation circuit is in electronic communication with the control circuit and is configured to determine a geolocation of a building. In such embodiments, the requirements database can store energy efficiency requirements as specific for geolocations and/or geolocation zones.

The fenestration product system can be configured to determine an energy efficiency requirement level for one or more fenestrations of the building based on the geolocation of the building and/or input from the system user. In some embodiments, the system can determine whether a fenestration unit at a given geolocation must meet specific thermal insulation properties, such as a U factor of less than or equal to 0.40 BTU/h*ft²*° F. or less than or equal to 0.30 BTU/h*ft²*° F.

Energy costs can vary based on geolocation. In some embodiments, the fenestration product system can access energy cost information specific for the geolocation of the building by interfacing with a database storing energy cost information or through an API. Energy cost information can then be utilized by the system to make energy costs associated with specific fenestration product selections more transparent. For example, in some embodiments, the product selection interface 1000 can also display information regarding expected energy costs associated with the selected fenestration unit 1002 and/or the alternatives 1032 and 1042. This can make it easier for the system user such as the product consultant 234 and/or the customer 236 to select products optimizing energy efficiency

In some embodiments, the system can also account for differences related to energy efficiency associated with different spots for fenestrations on the same building. For example, it will be appreciated that fenestrations with a southern exposure and/or shade from vegetation present different thermal insulation scenarios than do fenestrations with different exposures or different physical settings. As such, some fenestrations may be more impactful to the overall building energy efficiency than others. In various embodiments, the system can highlight specific fenestrations (such as in the regulatory output 238 or the product selection interface 1000 or in a fenestration product summary listing all fenestrations for a building) having the greatest impact on energy efficiency so that selections can be made to optimize energy efficiency.

Similarly, some homeowners may have different thermostat settings preferences that impact optimal energy efficiency properties of fenestrations. In some embodiments, these thermostat preferences can be input into the system to allow the system to present accurate estimates of energy usage and the costs thereof. In some embodiments, the user input and display unit 230 or another part of the system can include a temperature sensor (such as a thermistor or thermocouple) to measure a current temperature inside the building into which fenestration units will be installed as a proxy for thermostat preferences of the homeowner. In some embodiments, curtain usage preferences of the building owner or occupant can be input into the system to allow the system to present accurate estimates of energy usage and the costs thereof.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A coastal fenestration product system comprising:
a control circuit; and
a geolocation circuit, wherein the geolocation circuit is in electronic communication with the control circuit and is configured to determine a geolocation of a building;
wherein the coastal fenestration product system is configured to
receive an input from a system user regarding the building and fenestration locations therein; and
determine a wind loading requirement level for one or more fenestrations of the building based on the input from the system user and the geolocation of the building.

2. The coastal fenestration product system of claim 1, wherein the coastal fenestration product system is configured to determine a wind speed zone based on the geolocation of the building in order to determine the wind loading requirement level for one or more fenestrations of the building.

3. The coastal fenestration product system of claim 2, wherein the coastal fenestration product system is configured to calculate a proximity to an adjacent wind speed zone.

4. The coastal fenestration product system of claim 1, wherein the coastal fenestration product system is configured to identify a wind loading rating of one or more fenestrations for installation in the building.

5. The coastal fenestration product system of claim 1, wherein the coastal fenestration product system is configured to identify a selected fenestration as having a sufficient or insufficient wind loading rating with respect to the determined wind loading requirement level.

6. The coastal fenestration product system of claim 1, further comprising an image generation circuit, wherein the image generation circuit is in electronic communication with the control circuit and is configured to generate an output for a visual user interface displaying the wind loading requirement level for one or more fenestrations of the building and a wind loading rating of a replacement fenestration.

7. The coastal fenestration product system of claim 6, wherein the output for the visual user interface is configured based on a role identity of the system user.

8. The coastal fenestration product system of claim 6, wherein the image generation circuit is configured to generate an image of a fenestration location of the building with an image of a replacement fenestration superimposed thereon.

9. The coastal fenestration product system of claim 8, wherein the image generation circuit is configured to superimpose the wind loading requirement on a portion of the image of the fenestration location and superimpose a wind loading rating of the replacement fenestration on the image of the replacement fenestration.

10. The coastal fenestration product system of claim 1, further comprising a mobile coastal fenestration product system.

11. The coastal fenestration product system of claim 1, wherein the coastal fenestration product system is configured to load a project file from a non-volatile memory, the project file including a project geolocation, and cross-reference the project geolocation against a present geolocation as indicated by the geolocation circuit.

12. The coastal fenestration product system of claim 11, wherein the coastal fenestration product system is configured to issue a notice to the system user if the project geolocation does not match the present geolocation.

13. The coastal fenestration product system of claim 1, the geolocation circuit comprising a satellite signal receiver.

14. The coastal fenestration product system of claim 1, wherein the coastal fenestration product system is configured to generate a regulatory output listing regulatory requirements and wind loading levels for the one or more fenestrations of the building.

15. The coastal fenestration product system of claim 14, wherein the coastal fenestration product system is configured to transmit the regulatory output to a regulatory authority.

16. The coastal fenestration product system of claim 1, the input comprising one or more of fenestration unit size, fenestration proximity to a building corner, average building height, building category, and fenestration exposure.

17. The coastal fenestration product system of claim 1, wherein the building is a residential building.

18. The coastal fenestration product system of claim 1, wherein the building is a commercial building.

19. The coastal fenestration product system of claim 1, wherein the one or more fenestrations include windows and/or doors.

20. The coastal fenestration product system of claim 1, the system user comprising at least one selected from the group consisting of a building contractor, a building project sales professional, a building product consultant, an architect, and a building inspector.

21-35. (canceled)
